(19) United States
(12) Patent Application Publication
(10) Pub. No.: US 2010/0275348 A1
(43) Pub. Date: Nov. 4, 2010

(54) Mirror Position Adjuster

(76) Inventor: Graham Steele, Tyne & Wear (GB)

Correspondence Address: JACKSON WALKER, L.L.P., 112 E. PECAN, SUITE 2400, SAN ANTONIO, TX, 78205, US

(21) Appl. No.: 12/085,022

(22) PCT Filed: Nov. 14, 2006
(86) PCT No.: PCT/GB2006/004233

§ 371 Date: Jul. 26, 2010

(30) Foreign Application Priority Data
Nov. 14, 2005 (GB) 0523152.7

(51) Int. Cl. A42B 3/04; G02B 7/182

(52) U.S. Cl. 2/422; 359/879

(57) ABSTRACT

A mirror arrangement for a rear view mirror system in an article of headgear comprises first, second and third mirrors, the first mirror, in use, being adjacent the eyes of the user and the second mirror being located between the first and third mirrors, wherein the first mirror is mounted on a movable element that is movable towards and away from a fixed element, and wherein the first mirror is rotatably mounted on the said movable element.

### FIELD OF THE INVENTION

The present invention relates to an article of headgear with a rear view mirror system, and in particular to an adjuster which allows the position of a mirror element of the system to be adjusted.

### BACKGROUND OF THE INVENTION

Rear view mirror systems for cycling and motorcycling helmets are known, such as the helmet shown in PCT/GB94/00485 which relates to a helmet having a solid block of light transmissive material with reflective surfaces arranged within a channel in foam padding of a helmet. FR 2631789 discloses a helmet with an open, hollow channel through the helmet over the wearer's head. This helmet has two mirrors on the upper side of the channel and one mirror on the lower side of the channel. The mirrors direct light from behind the wearer to the wearer's eyes. Another helmet is known from PCT/GB96/02349 where a plurality of mirrors are arranged on a one piece mounting which is arranged in a channel in the foam padding inside the outer shell of the helment.

Another helmet is known from PCT/GB99/02312 which comprises first second and third mirrors, the first mirror being a concave, off-axis parabolic mirror arranged adjacent the eyes of the user, the second mirror being substantially flat and the third mirror being a convex, off axis parabolic mirror, where the first and the third mirrors have a common focus and the parabolas are related in a prescribed manner.

When the articles of headgear of PCT/GB94/00485, PCT/GB96/02349 and PCT/GB99/02312 are worn by an individual an image is presented to the wearer in the region of his eyes. PCT/GB96/002349 recognises that one configuration of mirror system may not suit all wearers or all postures of the wearer. Two solutions to this problem are proposed in this patent application. First, it is suggested that different head shapes may be accommodated by providing that the mirror proximate the wearer's eyes may be rotatable. Second, it is suggested that different mirror systems may be manufactured to suit different postures of the wearer, for example a specific mirror system configuration might be designed to suit a riding position where the rider sits with his back substantially straight and his head substantially upright.

Whilst the rotatable mirror provides for some adjustment to suit individual wearers, it has been found that the amount of adjustment does not provide good rearward vision for a sufficiently large range of head shapes. Also, whilst certain styles of bike require a certain posture to be adopted other types of bike and other activities require the wearer to adopt different postures. For example, when race riding the upper body is held substantially horizontal and the head is usually held angled forward of the vertical. A rider would therefore require two helmets, one for road use and the other for racing use.

It would therefore be desirable to provide an improved article of headgear.

### SUMMARY OF THE INVENTION

According to an aspect of the invention there is provided a mirror mounting arrangement for use in a rear view mirror system in an article of headgear comprising a first mirror, in use, being adjacent the eyes of the user and the second mirror being located to the rear of the first mirror, wherein the first mirror is mounted on a movable element that is movable towards and away from a fixed element, and wherein the first mirror is rotatably mounted on the said movable element.

Preferably a second mirror is mounted on the fixed element. Still more preferably the system includes a third mirror, which may be mounted in fixed relationship to the second mirror.

According to a first aspect of the invention there is provided a helmet as specified in claim 1.

According to a second aspect of the invention there is provided an article of headgear as specified in claim 13.

Further preferred features of the invention are specified in the dependent claims, and/or the description.

By mounting a rotatable mirror on a movable element, the article of headgear can be adjusted to suit different activities and different shapes of head and face of wearers. The movable element is arranged such that it may slide within a channel in the helmet, sliding of the element preferably being caused by a screw thread adjuster. This arrangement facilitates simple and accurate adjustment of the position of the element and hence the mirror. The angle of the mirror mounted on the slidable element is adjusted by rotation of the said mirror, the mounting of the mirror causing the mirror to be held securely in place once the wearer removes a rotating force therefrom.

### BRIEF DESCRIPTION OF THE DRAWINGS

In the drawings, which illustrate, preferred embodiments of a mirror position adjuster, and are by way of example:

FIG. 1 is a schematic representation of a slider and mirror mounting arrangement according to the invention;

FIG. 1a is a component drawing of the apparatus illustrated at FIG. 1.

FIG. 2 is a plan view of the mounting arrangement as shown in claim 1;

FIG. 3 is a cross-section of line A-A of FIG. 2;

FIG. 4 is a cross-section of an article of headgear comprising the components illustrated in FIGS. 1 to 3;

FIG. 5 is a schematic representation of the components illustrated in FIGS. 1 to 3 located in a mounting viewed from above;

FIG. 6 is a schematic representation of the components illustrated in FIGS. 1 to 3 located in a mounting viewed from the below; and

FIG. 7 is a schematic representation of the components illustrated in FIGS. 1 to 3 located in a mounting viewed from the side.

### DETAILED DESCRIPTION OF THE PREFERRED EMBODIMENTS

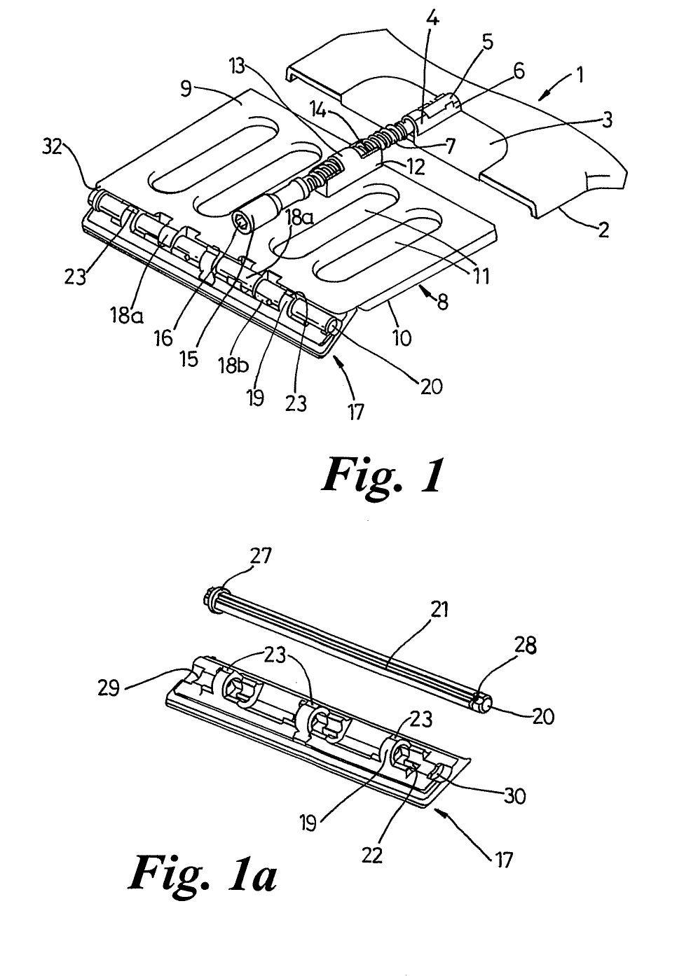

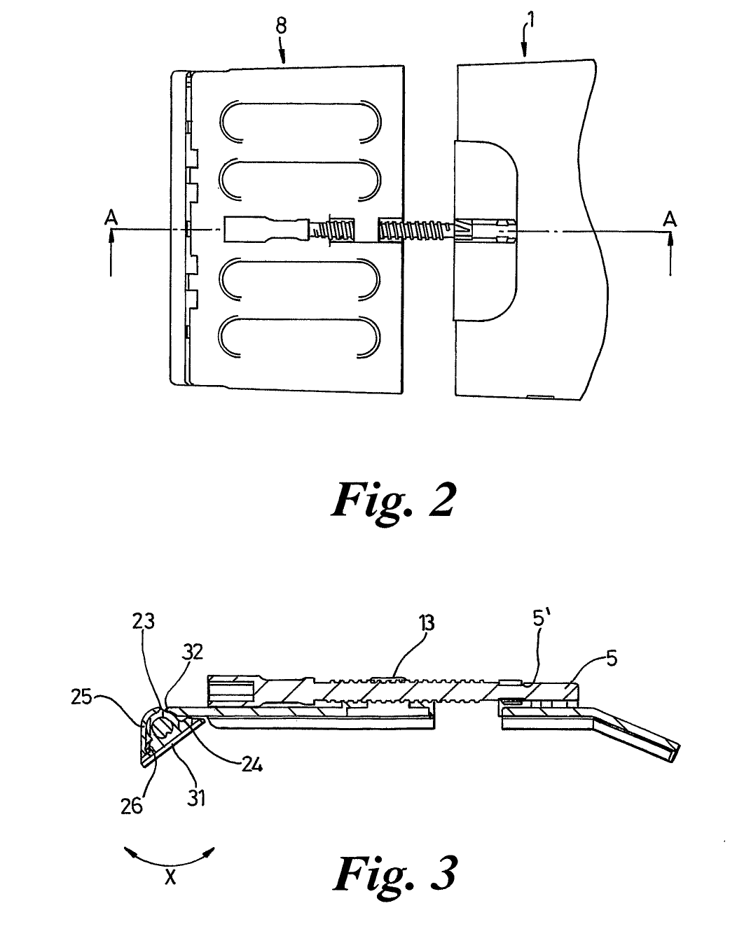

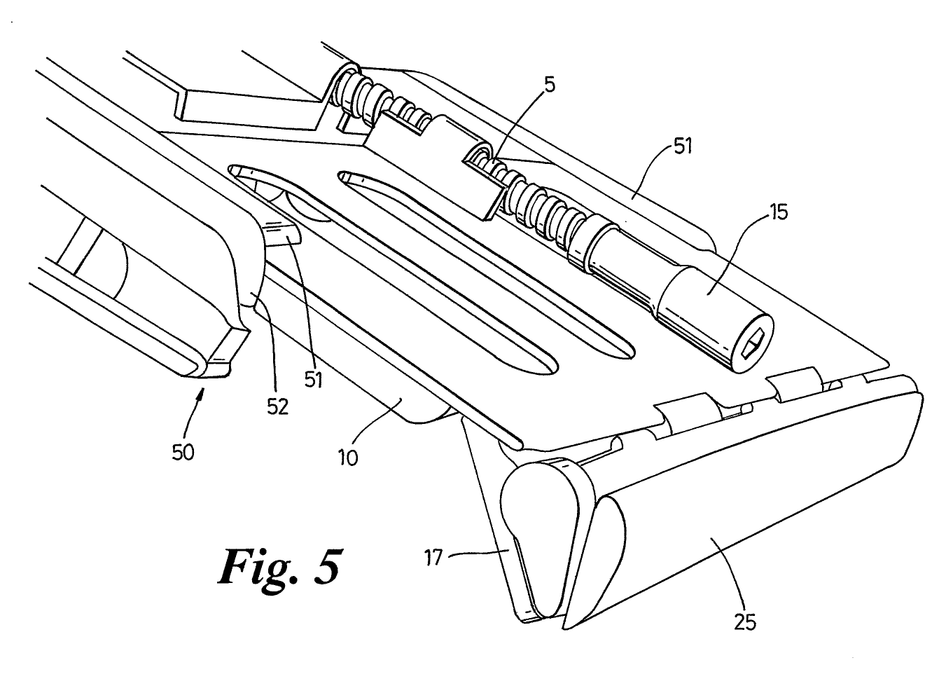

Referring now to FIGS. 1 to 3, a first element 1 including downwardly depending walls 2 which fit into corresponding grooves in a channel in a helmet (described in greater detail with reference to FIGS. 5 to 7). The upper surface of the first element 1 mounts a bracket 3 which includes a rod receiving element comprising a portion 4, which is substantially U-shaped in cross-section, and spaced axially from the U-shaped portion 4 a pair upward projections 6. The projections 6 have the same curvature as the U-shaped portion, but do not meet. One end of the rod 5 is rotatably mounted in the rod receiving element. As can be seen from FIG. 3 the rod has a region of reduced diameter 5′ which co-operates with the portion 4 to allow the rod 5 is to rotate freely in the rod receiving element but prevent axial movement of the said rod.

The rod 5 is threaded, threads 7 providing for movement of a second element 8 towards and away from the first element 1. The second element 8 comprises a flat plate 9 including a plurality of openings 11, and walls 10 depending downwardly from the flat plate 9 which fit into corresponding grooves in a channel in a helmet (see FIGS. 5 to 7). A bracket 12 is mounted on the upper surface of the fiat plate 9, the walls 14 of the bracket 12 being threaded internally. The bracket 12 includes a U-shaped portion 13 which holds the rod 5 in the bracket 12. An end portion 15 of the rod 5 includes a hexagonal opening 16 which can be engaged with an alien key to rotate the rod 5 thereby changing the position of the second element 8 relative to the first element 1. Alternatively, or in addition to the hexagonal opening 16, the end portion may be grasped by a wearer's fingers and rotated to change the position of the second element 8.

The end of the second element 8 remote from the first element 1 mounts a third element 17. The second and third elements 8, 17 each include hinge components 18a, 18b, and 19 respectively, which are aligned axially so that a hinge pin 20 may pass through the said hinge components 18a, 18b, and 19 to attach the third element 17 to the second element 8 and provide for rotation between the two said elements. As can be seen best from FIG. 1a, the hinge pin 20 includes a longitudinal indent 21 which cooperates with protrusion 22 of the third element 17 to restrain the hinge pin 20 against rotation. The hinge components 18a and 18b are resilient and the diameter of the opening formed between these components is slightly less than the diameter of the hinge pin 20. When assembled the hinge pin 20 forces the hinge components 18a, 18b apart slightly, the said hinge components being forced against the outer surface of the pin 20. The effect of this Configuration is that when the third element 17 is rotated the said element retains its position when the rotating force is removed.

The hinge pin 20 includes an axially extending rib 27 and indent 28. The rib 29 engages in a recess 29 in the third element 17, whilst an element 30 engages with the indent 28, thereby preventing the third element 17 from moving axially with respect to the hinge pin 20.

Referring now to FIG. 3, a mirror 31 is attached to the third element. The mirror may be planar or parabolic (as may be one or more of the mirrors 41 and 60—this being known from PCT/GB99/02312). The third element 17 (and hence the mirror 31) is rotatable between two limits. One of the limits consists of a stop 24 formed in the second element 8. The third element includes an indent 32 with which the stop 24 co-operates when in the position illustrated in FIG. 3. The third element 17 may be rotated in the direction indicated by arrow X until the protrusion 23 engages with the front edge 32 of the second element. The third element is provided with a cover 25 to protect the hinge from ingress of debris and to present a streamline profile.

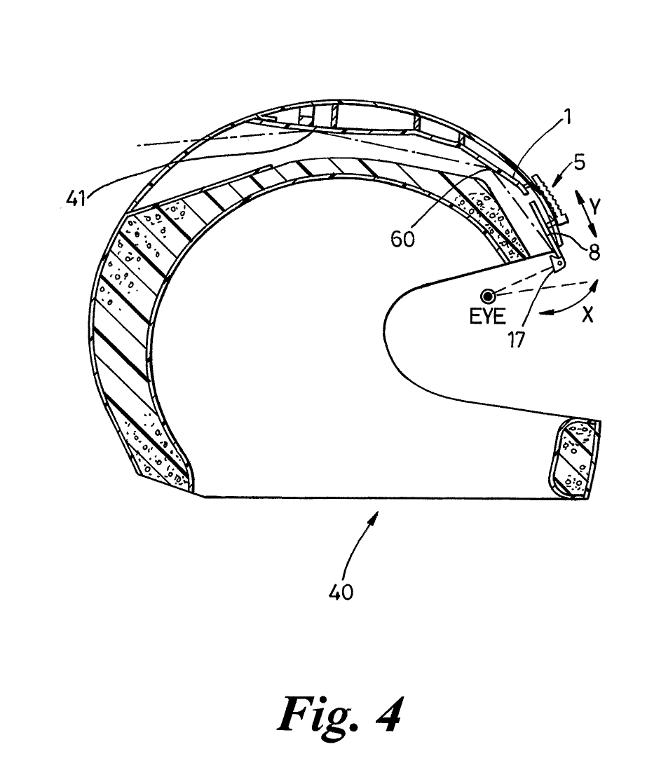

Referring now to FIG. 4, there is illustrated an article of headgear in the form of a helmet 40 comprising a first element 1 mounting mirrors 60 and 41, a second element 8 movable with respect to the first element 1 by means of rod 5, and a third element 17 rotatably mounted on one end of the second element 8. In use the helmet is worn for example by a motorcyclist. The user adjusts the position of mirror 31 by rotating the third element 17 in the direction indicated by arrow X and by moving the second element 8 in the direction indicated by arrow Y by turning the rod 5 until the position of the mirror 31 suits the users' physical make up and posture.

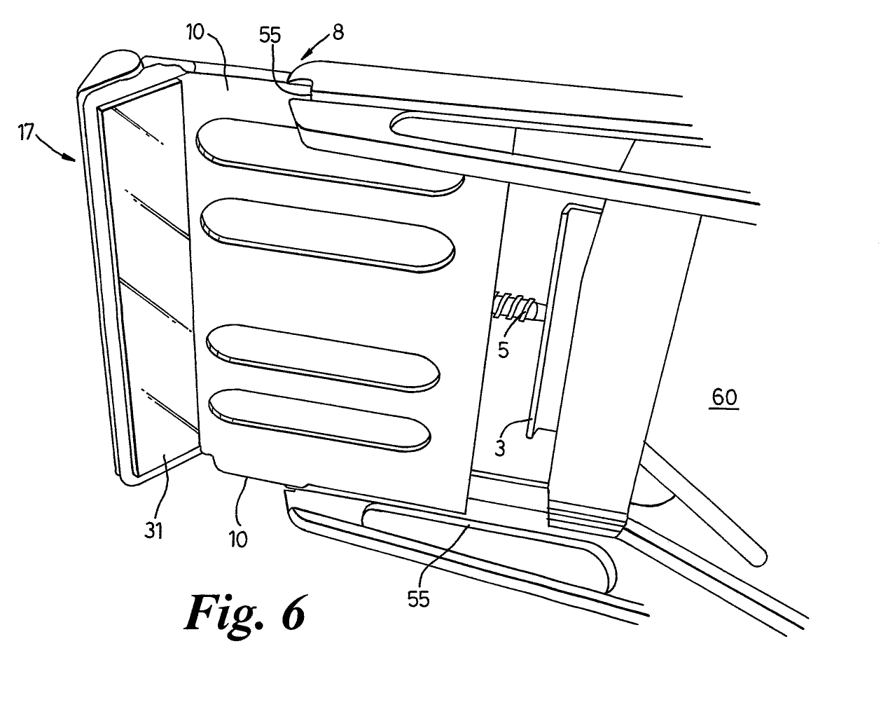

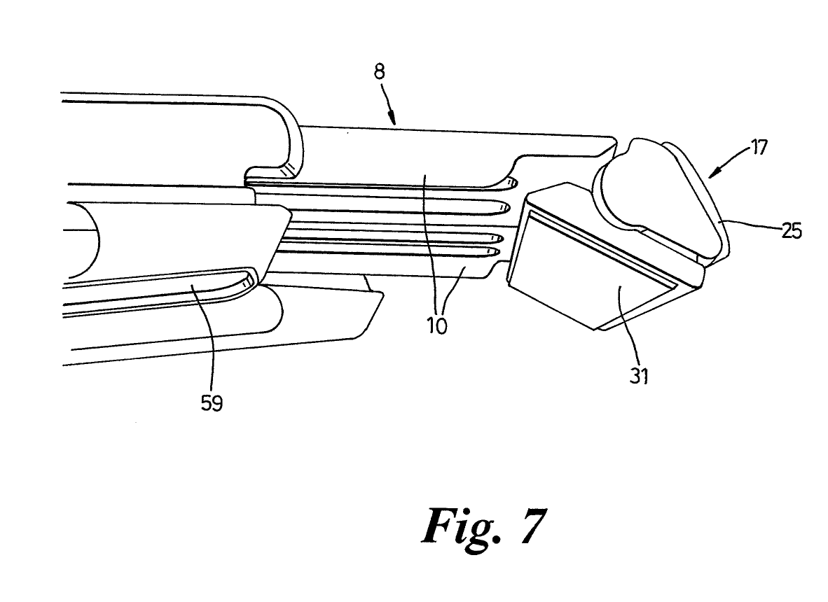

Referring now to FIGS. 5 to 7, a part of a mounting 50 sits in channel in an article of headgear. The first and second elements 1, 8 are situated in the mounting 50. The walls 2, 10 of the first and second elements respectively sit in channels in the sides of the mounting defined by side walls 52, inwardly projecting walls 51 and a step 55. The second element 8 is free to slide in the said channels. The rails 59 provide for attachment of the mounting 50 to the article of headgear. In FIGS. 5 and 6 the angular position of the mirror 31 is at its most acute with respect to the mirror 60. In FIG. 7 the angular position of mirror 31 is more obtuse than in FIGS. 5 and 6.

Referring specifically to FIG. 6, a mirror 60 is provided on the underside of at least a part of the first element 1. An image is reflected from mirror 60 onto the mirror 31, the angular of which is adjustable.

1. A mirror arrangement for a rear view mirror system in an article of headgear comprising first, second and third mirrors, the first mirror, in use, being adjacent the eyes of the user and the second mirror being located between the first and third mirrors, wherein the first mirror is mounted on a movable element that is movable towards and away from a fixed element, and wherein the first minor is rotatably mounted on the said movable element.

2. An arrangement according to claim 1, wherein the movable element is movable axially towards and away from the fixed element.

3. An arrangement according to claim 1, wherein the second mirror is mounted on the underside of the fixed element.

4. An arrangement according to claim 1, wherein the article of headgear further comprises a mounting and the movable and fixed elements are each mounted on the mounting.

5. An arrangement according to claim 4, wherein the movable element is slidable in the said mounting.

6. An arrangement according to claim 4, wherein the movable element includes walls which engage with channels in the mounting.

7. An arrangement according to claim 4, wherein the fixed element includes walls which engage with channels in the mounting.

8. An arrangement according to claim 7, wherein the first mirror is mounted on a mirror mount, and the said mirror mount is rotatably mounted on the said movable element.

9. An arrangement according to claim 1, wherein movement of the movable element is by means of threaded actuator attached to the fixed element by a mounting which permits rotation of the said member but prevents axial movement thereof, the movable element comprising a correspondingly threaded member whereby rotation of the actuator causes the movable element to move towards or away from the fixed element.

10. An arrangement according to claim 9, wherein the fixed element mounts the third mirror.

11. An arrangement according to claim 10, wherein the first mirror is rotatably mounted on the movable element by means of a hinge.

12. An arrangement according to claim 11, wherein the hinge is arranged to generate a resistance force acting against rotation of the first mirror, and whereby a force greater than the resistance force causes rotation of the first minor, wherein the first mirror remains substantially stationary upon application thereto of a force less than the resistance force.

13. An article of headgear comprising a mirror arrangement as claimed in claim 12.

14. (canceled)

15. (canceled)
